(19) United States
(12) Patent Application Publication
(10) Pub. No.: US 2026/0332079 A1
(43) Pub. Date: Oct. 22, 2026

(54) INVERTER CONTROL DEVICE

(71) Applicant: Hitachi Astemo, Ltd., Hitachinaka-shi, Ibaraki (JP)

(72) Inventors: Asuka KAMATA, Hitachinaka-shi (JP); Shun TANIGUCHI, Tokyo (JP); Eigo KISHIMOTO, Hitachinaka-shi (JP); Shinya YAMASHITA, Hitachinaka-shi (JP)

(73) Assignee: Hitachi Astemo, Ltd., Hitachinaka-shi, Ibaraki (JP)

(21) Appl. No.: 19/109,657

(22) PCT Filed: Sep. 12, 2022
(86) PCT No.: PCT/JP2022/034104

§ 371 Date: Mar. 7, 2025

(51) Int. Cl. H02P 27/08; H02P 21/14

(52) U.S. Cl. CPC H02P 27/085; H02P 21/14; H02P 2209/11

(57) ABSTRACT

An inverter control device reduces a voltage error caused by a dead time and suppresses torque shock by controlling the switching operation of an inverter that converts a direct-current voltage into an alternating-current voltage and applies the alternating-current voltage to a motor, by pulse width modulation. The inverter control device of Embodiment 1 is provided with a dead-time compensation unit that performs dead-time compensation for compensating for an error of the output voltage of the inverter caused by the dead time of the inverter. The dead-time compensation unit performs the dead-time compensation on the basis of the difference θvi between the current phase angle θi indicating the phase angle for outputting a current of the motor and the voltage phase angle θv for outputting a voltage corresponding to the current.

### TECHNICAL FIELD

The present invention relates to an inverter control device.

### BACKGROUND ART

Inverter control devices are widely used to control the switching operation of an inverter that converts direct-current voltage into alternating-current voltage and applies the alternating-current voltage to an alternating-current motor, by pulse width modulation (hereinafter also referred to as “PWM”). In this type of inverter control device, in order to increase the rotation speed of the alternating-current motor, a technique for operating the inverter in an overmodulation region in which the voltage command value in the output voltage of the inverter exceeds the maximum output level of a sine wave is known. In this case, the inverter control device may be operated by a one-pulse control mode or a three-pulse control mode that generates one pulse or three pulses per cycle of the fundamental wave of the inverter's output voltage. The inverter control device can switch the control modes in accordance with the operating region of the alternating-current motor.

In an inverter, a dead time is provided, which is an interval during which both the upper and lower arms are turned off to prevent a short circuit during the switching. As a result, an error (hereinafter also referred to as “voltage error”) occurs between the output voltage of the inverter and its voltage command value. The voltage error caused by the dead time can lead to torque shock, where the motor fails to output the commanded torque when the inverter control device switches the control modes. Therefore, it is important to reduce the voltage error caused by the dead time to prevent the occurrence of torque shock.

Patent Literature 1 discloses a technique for performing dead-time compensation by which, in a phase reference synchronization control mode, the phase threshold used to generate a switching command that controls the on/off of the inverter's switching elements is corrected with a dead-time compensation phase.

### CITATION LIST

### Patent Literature

Patent Literature 1: JP 2011-15566 A

### SUMMARY OF INVENTION

### Technical Problem

In the technique disclosed in Patent Literature 1, the dead-time compensation phase is calculated on the basis of a detection signal of current supplied to the motor from the inverter and the fundamental frequency of the voltage command value. Consequently, current polarity calculation at the switching timing is required. In other words, the technique disclosed in Patent Literature 1 necessitates high-speed current detection to perform dead-time compensation, making it difficult to easily reduce the voltage error caused by the dead time.

The present invention has been made in view of the above, and has the objective of easily reducing the voltage error caused by the dead time and suppressing torque shock.

### Solution to Problem

In order to solve the problem, an inverter control device of the present invention controls a switching operation of an inverter that converts a direct-current voltage into an alternating-current voltage and applies the alternating-current voltage to an alternating-current motor, by pulse width modulation. The inverter control device includes a dead-time compensation unit for performing dead-time compensation for compensating for an error of an output voltage of the inverter caused by a dead time of the inverter. The dead-time compensation unit performs the dead-time compensation on the basis of a difference between a current phase angle indicating a phase angle for outputting a current of the alternating-current motor and a voltage phase angle for outputting a voltage corresponding to the current.

### Advantageous Effects of Invention

According to the present invention, the voltage error caused by the dead time can be easily reduced, and the torque shock can be suppressed.

Other problems, configurations, and effects will become apparent from the following description of the embodiments.

### BRIEF DESCRIPTION OF DRAWINGS

FIG. 1 is a configuration diagram of a motor drive system equipped with the inverter control device according to Embodiment 1.

FIG. 2 is a configuration diagram of a three-pulse/one-pulse calculation unit when a current phase angle and a voltage phase angle are used as inputs.

FIG. 3 is a configuration diagram of a three-pulse/one-pulse calculation unit when a current command value and a voltage command value are used as inputs.

FIG. 4 is an explanatory diagram of the voltage waveform when no voltage error caused by the dead time occurs.

FIGS. 5A-5C are an explanatory diagram of the calculations of a dead-time compensation unit when (1) Δα<θvi<α is satisfied.

FIGS. 6A-6C are an explanatory diagram of the calculations of dead-time compensation unit when (2) α+Δα<θvi<π−α is satisfied.

FIGS. 7A-7C are an explanatory diagram of the calculations of dead-time compensation unit when (3) π−α+Δα<θvi<π is satisfied.

FIGS. 8A-8C are an explanatory diagram of the calculations of dead-time compensation unit when (4) π+Δα<θvi<π+α is satisfied.

FIGS. 9A-9C are an explanatory diagram of the calculations of dead-time compensation unit 183 when (5) π+α+Δα<θvi<2π−α is satisfied.

FIGS. 10A-10C are an explanatory diagram of the calculations of dead-time compensation unit 183 when (6) π−α+Δα<θvi<2π is satisfied.

FIG. 11 is a table showing the relationship between the difference between voltage phase angle and current phase angle, amplitude error, and phase angle error.

FIG. 12 is an explanatory diagram of the operational effects of the inverter control device shown in FIG. 1.

FIG. 13 is a configuration diagram of the three-pulse/one-pulse calculation unit included in the inverter control device of Embodiment 2.

FIG. 14 is a table showing the relationship between the difference between voltage phase angle and current phase angle, and phase angle error.

FIG. 15 is a configuration diagram of the inverter control device of Embodiment 3.

### DESCRIPTION OF EMBODIMENTS

Hereinafter, embodiments of the present invention will be described with reference to the drawings. Note that in each embodiment, configurations denoted by the same reference numerals have the same functions across the embodiments unless specifically mentioned otherwise, and their descriptions will be omitted.

### Embodiment 1

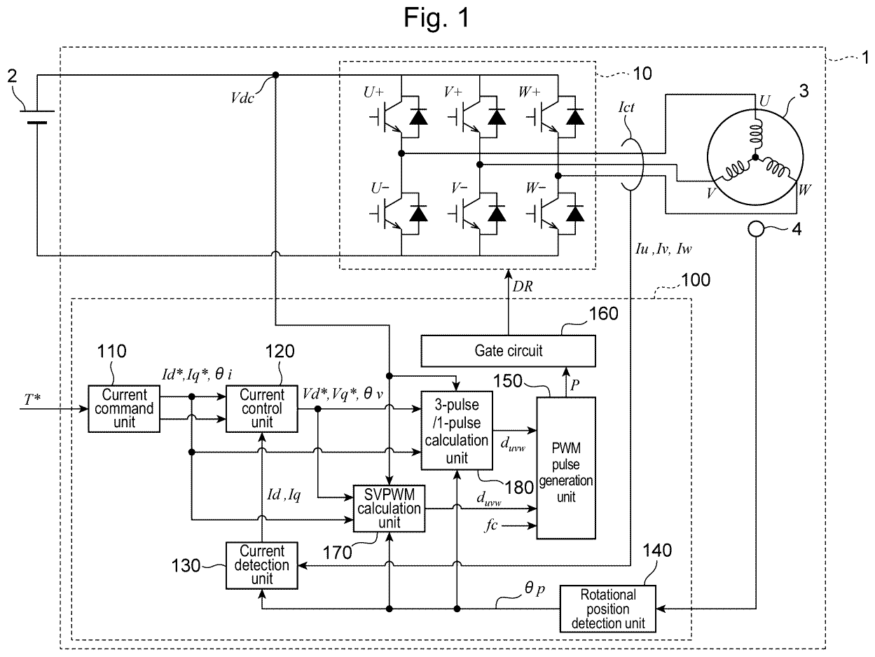

An inverter control device 100 of Embodiment 1 will be described with reference to FIG. 1 to FIG. 12. FIG. 1 is a configuration diagram of a motor drive system 1 equipped with the inverter control device 100 of Embodiment 1.

The motor drive system 1 is connected to a battery 2 and is equipped with an inverter 10 (inverter power unit), the inverter control device 100, and an alternating-current motor 3 (hereinafter also referred to as “motor 3”).

The battery 2 is a direct-current voltage source for the inverter 10. The direct-current voltage Vdc (hereinafter also referred to as “power supply voltage Vdc”) of the battery 2 is converted by the inverter 10 into a three-phase alternating-current voltage with variable voltage and variable frequency, and applied to the motor 3. The motor 3 is a synchronization motor that is rotationally driven by the application of the three-phase alternating-current voltage. The motor 3 has a rotational position sensor 4 mounted thereto to control the phase of the three-phase alternating-current voltage applied from the inverter 10, in accordance with the phase of the induced voltage of the motor 3. The rotational position sensor 4 is configured, for example, using a resolver or the like composed of a core and windings. Alternatively, the rotational position sensor 4 may be configured using a rotational position sensor using a GMR sensor or a Hall element.

The inverter control device 100 is a device for controlling the inverter 10. The inverter control device 100 is configured, for example, using a microcomputer. The inverter control device 100 can realize various functions of the inverter control device 100 by performing a predetermined program in the microcomputer. Alternatively, the inverter control device 100 may realize some or all of the various functions of the inverter control device 100 using hardware circuits such as logic IC or FPGA.

The inverter control device 100 is provided with, as its various functions, a current command unit 110, a current control unit 120, a current detection unit 130, a rotational position detection unit 140, a PWM pulse generation unit 150, a gate circuit 160, an SVPWM calculation unit 170, and a three-pulse/one-pulse calculation unit 180.

The rotational position detection unit 140 detects the rotational position θp, which is the position of the rotor of the motor 3, on the basis of the output signal of the rotational position sensor 4.

The current detection unit 130 acquires the three-phase current detected values Iuvw (Iu, Iv, Iw) flowing through the motor 3 from a current sensor Ict. The current detection unit 130 detects the dq-axis current detected values Idq (Id, Iq) by performing three-phase to two-phase conversion on these current detected values on the basis of the rotational position θp detected by the rotational position detection unit 140.

The inverter control device 100 has a current control function for controlling the output of the motor 3. The current command unit 110 calculates the dq-axis current command values Idq* (Id*, Iq*) on the basis of the torque command value T* output from a higher-level control device (not shown). The current command unit 110 outputs the calculated dq-axis current command values Idq* to the current control unit 120, the SVPWM calculation unit 170, and the three-pulse/one-pulse calculation unit 180. The current command unit 110 may also calculate the current phase angle θi, which indicates the phase angle of the dq-axis current command values Idq*, from the dq-axis current command values Idq*. The current command unit 110 may output the calculated current phase angle θi to the current control unit 120, the SVPWM calculation unit 170, and the three-pulse/one-pulse calculation unit 180.

The current control unit 120 calculates the dq-axis voltage command values Vdq* (Vd*, Vq*) as the voltage command value for the output voltage of the inverter 10 corresponding to the dq-axis current command values Idq* output from the current command unit 110. Specifically, the current control unit 120 calculates the dq-axis voltage command values Vdq* so that the dq-axis current command values Idq* output from the current command unit 110 match the dq-axis current detected values Idq detected by the current detection unit 130. The current control unit 120 outputs the calculated dq-axis voltage command values Vdq* to the SVPWM calculation unit 170 and the three-pulse/one-pulse calculation unit 180. The current control unit 120 may also calculate the voltage phase angle θv, which indicates the phase angle of the dq-axis voltage command values Vdq*, from the dq-axis voltage command values Vdq*. The current control unit 120 may output the calculated voltage phase angle θv to the SVPWM calculation unit 170 and the three-pulse/one-pulse calculation unit 180.

The three-pulse/one-pulse calculation unit 180 calculates a modulation wave on the basis of the voltage command value in the output voltage of the inverter 10. That is, the three-pulse/one-pulse calculation unit 180 is a modulation wave calculation unit that calculates a modulation wave corresponding to the output voltage of the inverter 10. Specifically, the three-pulse/one-pulse calculation unit 180 calculates the three-phase voltage command values Vuvw* (Vu*, Vv*, Vw*) by performing two-phase to three-phase conversion on the dq-axis voltage command values Vdq* output from current control unit 120, using the rotational position θp. Among the three-phase voltage command values Vuvw*, Vu* is the U-phase voltage command value, Vv* is the V-phase voltage command value, and Vw* is the W-phase voltage command value. Then, the three-pulse/one-pulse calculation unit 180 generates the modulation wave signal duvw indicating the modulation wave represented by the three-phase voltage command values Vuvw*, and outputs it to the PWM pulse generation unit 150. At this time, the three-pulse/one-pulse calculation unit 180 may select a modulation scheme other than sinusoidal modulation, and represent the three-phase voltage command values Vuvw* using waveforms other than sinusoidal waveform, such as a trapezoidal wave or a waveform in which harmonics of a predetermined order are superimposed on a sinusoidal wave.

Additionally, the three-pulse/one-pulse calculation unit 180 may calculate the modulation factor MF of the output voltage of the inverter 10 on the basis of the power supply voltage Vdc and the dq-axis voltage command values Vdq* output from current control unit 120, and then output the modulation factor MF to the PWM pulse generation unit 150 instead of the modulation wave signal duvw. Further, the three-pulse/one-pulse calculation unit 180 may calculate the modulation wave signal duvw and the modulation factor MF and output both to the PWM pulse generation unit 150. That is, the three-pulse/one-pulse calculation unit 180 can calculate at least one of the modulation wave signal duvw and the modulation factor ME.

The PWM pulse generation unit 150 performs three-phase pulse width modulation (PWM) on the basis of the modulation wave signal duvw or the modulation factor MF calculated by the three-pulse/one-pulse calculation unit 180, and generates a PWM pulse signal P for controlling the switching operation of the inverter 10. For example, the PWM pulse generation unit 150 compares the carrier that periodically varies with the carrier frequency fc, with the modulation wave signal duvw. The PWM pulse generation unit 150 can then generate the PWM pulse signal P by determining the positions (phases) of the rising and falling edges (hereinafter also referred to as “pulse edges”) of each pulse on the basis of the comparison result, using a well-known scheme. In this case, the PWM pulse generation unit 150 may keep the carrier frequency fc constant or vary the carrier frequency fc according to the rotational speed of the motor 3. Alternatively, the PWM pulse generation unit 150 may generate the PWM pulse signal P by directly determining the position of each pulse edge by calculation on the basis of the modulation factor MF, without using the carrier and modulation wave signal duvw. Alternatively, the PWM pulse generation unit 150 may generate the PWM pulse signal P by yet another method. In any case, the PWM pulse generation unit 150 only needs to generate the PWM pulse signal P for controlling the inverter 10 at each predetermined control cycle in accordance with the voltage command value in the output voltage of the inverter 10, and any method may be employed.

The gate circuit 160 outputs a drive signal DR corresponding to the PWM pulse signal P to the inverter 10. The inverter 10 includes a plurality of semiconductor switch elements respectively corresponding to the phases of the three-phase alternating-current voltage, and each semiconductor switch element is on/off controlled by the drive signal DR. In this way, the output voltage of the inverter 10 is adjusted in accordance with the control of the inverter control device 100.

The SVPWM calculation unit 170 calculates the modulation wave when the space vector pulse width modulation (SVPWM) control mode is being used. That is, the SVPWM calculation unit 170 is a modulation wave calculation unit that calculates a modulation wave corresponding to the output voltage of the inverter 10. Specifically, the SVPWM calculation unit 170 calculates the three-phase voltage command values Vuvw* by performing two-phase to three-phase conversion on the dq-axis voltage command values Vdq* output from current control unit 120, using the rotational position θp. Then, the SVPWM calculation unit 170 performs dead-time compensation on the three-phase voltage command values Vuvw* using the dq-axis current command values Idq*. Then, the SVPWM calculation unit 170 calculates the duty ratio duvw by dividing the dead-time compensated three-phase voltage command values Vuvw* by the power supply voltage Vdc. Then, the SVPWM calculation unit 170 outputs the calculated duty ratio duvw to the PWM pulse generation unit 150.

The foregoing has described a configuration example of the motor drive system 1 when the current of the motor 3 is controlled in accordance with the dq-axis current command values Idq* from the current command unit 110 with reference to FIG. 1. However, the configuration of FIG. 1 can be applied even when other control methods are adopted. For example, when the rotational speed of the motor 3 is controlled, the inverter control device 100 may calculate the motor rotational speed or on the basis of the time variation of the rotational position θp, and generate a voltage command value or a current command value matching the speed command value from a higher-level control device. Further, when controlling the output torque of the motor 3, the inverter control device 100 may generate the current command value (Idq*) using a relational expression or a map between the motor current (Idq) and the motor torque.

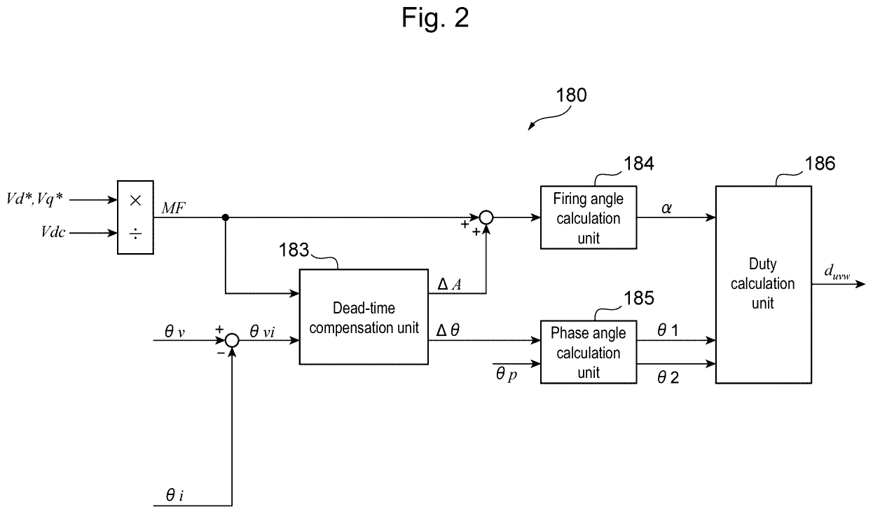

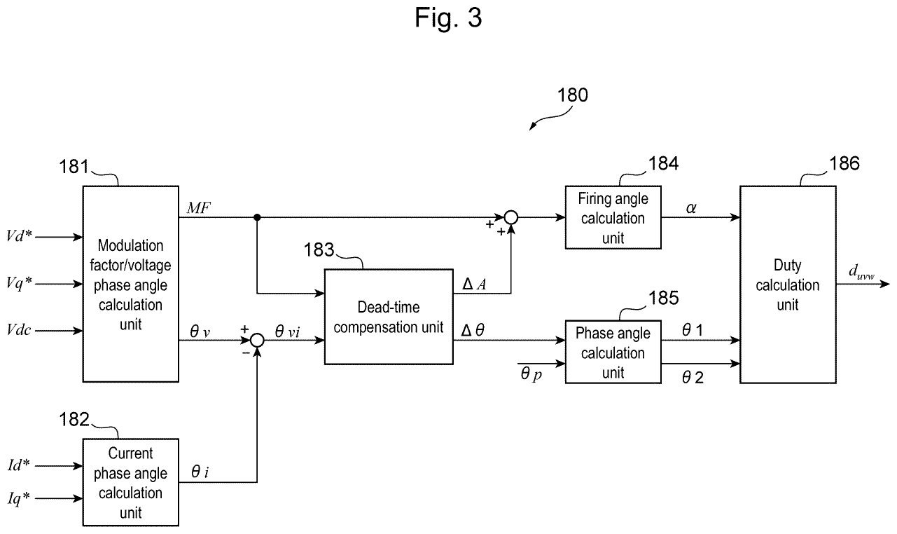

FIG. 2 is a configuration diagram of the three-pulse/one-pulse calculation unit 180 when the current phase angle θi and the voltage phase angle θv are used as inputs. FIG. 3 is a configuration diagram of the three-pulse/one-pulse calculation unit 180 when the current command values Idq* and the voltage command values Vdq* are used as inputs.

The three-pulse/one-pulse calculation unit 180, as shown in FIG. 2 and FIG. 3, is provided with a dead-time compensation unit 183, a firing angle calculation unit 184, a phase angle calculation unit 185, and a duty calculation unit 186. The three-pulse/one-pulse calculation unit 180 shown in FIG. 3 is further provided with a modulation factor/voltage phase angle calculation unit 181 and a current phase angle calculation unit 182.

FIG. 2 shows an example in which the current phase angle θi obtained by calculating the amplitude and phase angle with respect to a torque command by means of a table is input directly to the three-pulse/one-pulse calculation unit 180, and the voltage phase angle θv obtained using voltage phase control is input directly to the three-pulse/one-pulse calculation unit 180. FIG. 3 shows an example in which the dq-axis current command values Idq* output from the current command unit 110 is input to the three-pulse/one-pulse calculation unit 180, and the dq-axis voltage command values Vdq* output from the current control unit 120 is input to the three-pulse/one-pulse calculation unit 180. The inverter control device 100 may adopt either the three-pulse/one-pulse calculation unit 180 shown in FIG. 2, or the three-pulse/one-pulse calculation unit 180 shown in FIG. 3.

The following describes an example in which the inverter control device 100 has adopted the three-pulse/one-pulse calculation unit 180 shown in FIG. 3 and controls the switching operation in a three-pulse control mode.

The modulation factor/voltage phase angle calculation unit 181 calculates the modulation factor MF and the voltage phase angle θv on the basis of the dq-axis voltage command values Vdq* of the output voltage of the inverter 10. Specifically, the modulation factor/voltage phase angle calculation unit 181 calculates the root sum of squares of the d-axis voltage command value Vd* and the q-axis voltage command value Vq* output from the current control unit 120. Then, the modulation factor/voltage phase angle calculation unit 181 calculates the modulation factor MF by dividing the calculated root sum of squares by the power supply voltage Vdc.

The modulation factor/voltage phase angle calculation unit 181 calculates the voltage phase angle θv from the dq-axis voltage command values Vdq* using Formula 1.

$$θ v = Atan ( \frac{{Vq}^{*}}{{Vd}^{*}} ) \qquad [ Formula 1 ]$$

The current phase angle calculation unit 182 calculates the current phase angle θi on the basis of the dq-axis current command values Idq* of the current flowing through the motor 3. Specifically, the current phase angle calculation unit 182 calculates the current phase angle θi from the dq-axis current command values Idq* using Formula 2.

$$θ i = Atan ( \frac{{Iq}^{*}}{{Id}^{*}} ) \qquad [ Formula 2 ]$$

Note that the current phase angle calculation unit 182 may calculate the current phase angle θi on the basis of the dq-axis current detected values Idq, which are the detected values of the current flowing through the motor 3. Similarly, the modulation factor/voltage phase angle calculation unit 181 may calculate the modulation factor MF and the voltage phase angle θv on the basis of the detected values of the output voltage of the inverter 10.

The dead-time compensation unit 183 performs dead-time compensation for compensating for an error of the output voltage caused by the dead time Δα of the inverter 10. Specifically, the dead-time compensation unit 183 performs dead-time compensation when the switching operation of the inverter 10 is controlled by at least one of the one-pulse control mode and the three-pulse control mode.

The one-pulse control mode is a control mode that generates one pulse per fundamental wave cycle of the output voltage of the inverter 10. The one-pulse control mode is used in a region in which the fundamental wave frequency of the output voltage of the inverter 10 is high. The three-pulse control mode is a control mode that generates three pulses per fundamental wave cycle of the output voltage of the inverter 10. The three-pulse control mode is used in a region in which the fundamental wave frequency of the output voltage of the inverter is intermediate. An SVPWM control mode is a control mode that generates a pulse by comparing the carrier with the modulation wave based on their relative magnitudes. The SVPWM control mode is used in a region in which the fundamental wave frequency of the output voltage of the inverter 10 is low.

The dead-time compensation unit 183 performs dead-time compensation on the basis of the difference θvi (=θv−θi) between the current phase angle θi, which indicates the phase angle for outputting the current of the motor 3, and the voltage phase angle θv for outputting a voltage corresponding to the current. Specifically, dead-time compensation unit 183 calculates at least one of the amplitude error ΔA and the phase angle error Δθ of the output voltage, which are voltage errors caused by the dead time Δα, as a dead-time compensation amount. The three-pulse/one-pulse calculation unit 180 uses the amplitude error ΔA calculated as the dead-time compensation amount to correct the modulation factor MF, which is used for calculating the firing angle α of the output voltage. Also, the three-pulse/one-pulse calculation unit 180 uses the phase angle error Δθ calculated as the dead-time compensation amount to correct the phase angles θ1 and θ2 of the output voltage. In this way, the dead-time compensation unit 183 can perform dead-time compensation.

The firing angle α refers to the pulse width that needs to be adjusted when the number of pulses per fundamental wave cycle of the output voltage is set. Between the firing angle α and the modulation factor MF, there is a relationship as expressed in Formula 3.

$$MF = \frac{4}{n} \{ {\int }_{0}^{\frac{π}{2} - α} ( - 1 ) sin θ d θ + {\int }_{\frac{π}{2} - α}^{\frac{π}{2}} sin θ d θ \} = \frac{4}{π} ( 2 cos α - 1 ) \qquad [ Formula 3 ]$$

Thus, the firing angle α can be expressed using the modulation factor MF as in Formula 4.

$$α = {cos}^{- 1} ( \frac{\frac{π}{4} MF + 1}{2} ) \qquad [ Formula 4 ]$$

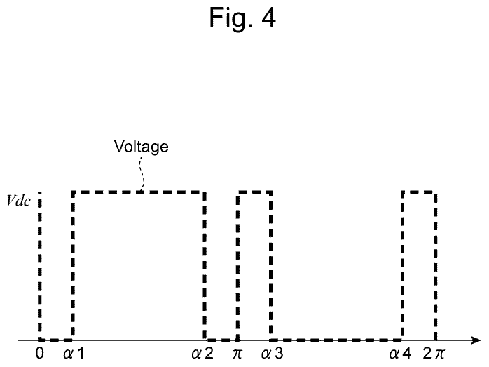

The dead-time compensation unit 183 calculates the amplitude error ΔA and the phase angle error Δθ as the dead-time compensation amount in accordance with the relationship between the firing angle α and the difference Ovi. The details of the calculations for the amplitude error ΔA and the phase angle error Δθ by the dead-time compensation unit 183 will be described with reference to FIG. 4 to FIG. 11.

FIG. 4 is an explanatory diagram of the voltage waveform when no voltage error due to the dead time is caused.

When no voltage error due to the dead time is caused, the switch timings α1 to α4 in the interval [0, 2π] with respect to the firing angle α can be expressed as in Formula 5.

α1=α

α2=π−α

α3=π+α

α4=2π−α [Formula 5]

The Fourier coefficients an and bn obtained by performing a Fourier series expansion of the output voltage of the inverter 10 using the power supply voltage Vdc, the firing angle α, and the dead time Δα with respect to the switch timings α1 to α4 can be expressed as in Formula 6.

$${a}_{n} = \frac{2 Vdc}{π} ( 2 cos α - 1 ) \qquad [ Formula 6 ]$$

$${b}_{n} = 0$$

The amplitude A of the output voltage of the inverter 10 can be expressed using the Fourier coefficients an and bn of Formula 6 as in Formula 7.

$$A = \frac{2}{Vdc} \sqrt{{a}_{n}^{2} + {b}_{n}^{2}} = \frac{4}{π} ( 2 cos α - 1 ) \qquad [ Formula 7 ]$$

The phase angle error Δθ of the output voltage of the inverter 10 when no voltage error due to the dead time is caused can be expressed as in Formula 8.

Δθ=tan⁻¹(bₙ/aₙ)=0 [Formula 8]

The dead-time compensation unit 183 calculates the amplitude error ΔA and the phase angle error Δθ as the dead-time compensation amount by determining the above Formula 5 to Formula 8 in accordance with the relationship between the firing angle α and the difference θvi.

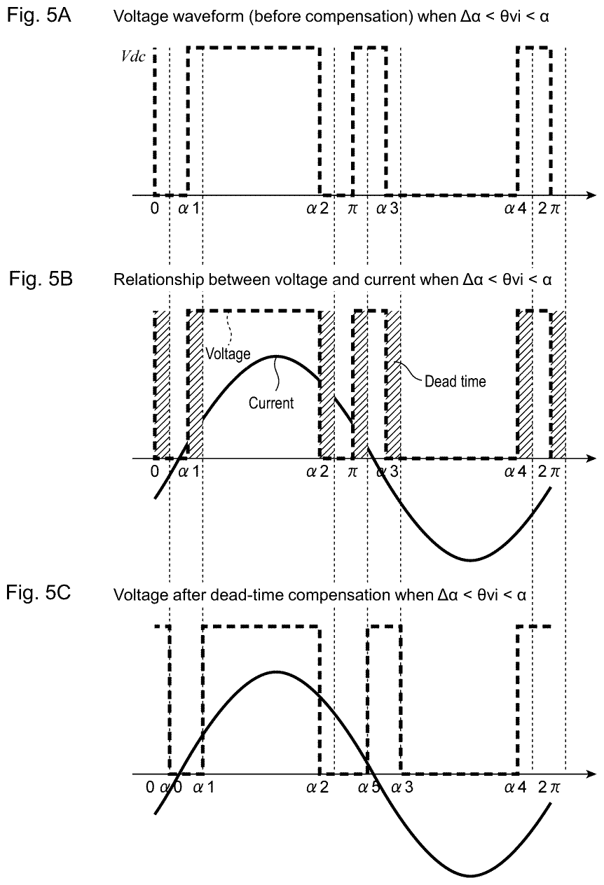

FIG. 5 shows explanatory diagrams of the calculations of the dead-time compensation unit 183 when (1) Δα<θvi<α is satisfied.

The top (a) of FIG. 5 shows the voltage waveform prior to dead-time compensation. With respect to the firing angle α, the switch timings α1 to α4 in the interval [0, 2π] of one fundamental wave cycle can be expressed based on FIG. 4 and Formula 5, as in Formula 9.

α1=α

α2=π−α

α3=π+α

α4=2π−α [Formula 9]

In reality, there is a phase difference between the output voltage of the inverter 10 and the current flowing through the motor 3. The inventor focused on the fact that the amplitude error ΔA and the phase angle error Δθ vary depending on the difference θvi between the voltage phase angle θv and the current phase angle θi. Specifically, for each of cases (1) to (6) shown in Formula 10 corresponding to the ranges of the difference θvi between the voltage phase angle θv and the current phase angle θi, the amplitude error ΔA and the phase angle error Δθ take different values. Therefore, the dead-time compensation unit 183 calculates the amplitude error ΔA and the phase angle error Δθ for each of the cases (1) to (6) shown in Formula 10.

[Formula 10]

Δα<θvi<α (1)

α+Δα<θvi<π−α (2)

π−α+Δα<θvi<π (3)

π+Δα<θvi<π+α (4)

π+α+Δα<θvi<2π−α (5)

2π−α+Δα<θvi<2π (6)

When (1) Δα<θvi<α is satisfied, the relationship between the output voltage of the inverter 10 prior to dead-time compensation and the current flowing through the motor 3 is as shown in the middle (b) of FIG. 5. The output voltage after dead-time compensation when (1) Δα<θvi<α is satisfied has the waveform as shown at the bottom (c) of FIG. 5. The switch timings α0 to α5 shown at the bottom (c) of FIG. 5 can be expressed using the firing angle α and the dead time Δα, as in Formula 11.

α0=Δα

α1=α+Δα

α2=π−α

α3=π+α+Δα

α4=2π−α [Formula 11]

The dead-time compensation unit 183 calculates the amplitude error ΔA and the phase angle error Δθ, which are the correction amounts for the modulation factor and the phase angle, so that, at the switch timings α0 to α5, the average modulation factor and phase angle in one fundamental wave cycle match those when no voltage error due to the dead time is caused.

Specifically, the dead-time compensation unit 183 can calculate the Fourier coefficients an and bn using the power supply voltage Vdc, the firing angle α, and the dead time Δα as in Formula 12.

$${a}_{n} \approx \frac{2 Vdc}{π} ( 2 cos α - Δ α sin α - 1 ) \qquad [ Formula 12 ]$$

$${b}_{n} \approx 0$$

Thus, the dead-time compensation unit 183 can calculate the amplitude A of the output voltage of the inverter 10 using the Fourier coefficients an and bn of Formula 12, as in Formula 13.

$$A = \frac{2}{Vdc} \sqrt{{a}_{n}^{2} + {b}_{n}^{2}} = \frac{4}{π} ( 2 cos α - Δ α sin α - 1 ) \qquad [ Formula 13 ]$$

Compared with Formula 7 and Formula 8, which were explained using FIG. 4 for the case where no voltage error due to the dead time is caused, the dead-time compensation unit 183 can calculate the amplitude error ΔA and the phase angle error Δθ when (1) Δα<θvi<α is satisfied as in Formula 14.

$$Δ A \approx \frac{4}{π} ( - Δ α \times α ) \qquad [ Formula 14 ]$$

$$Δ θ = 0$$

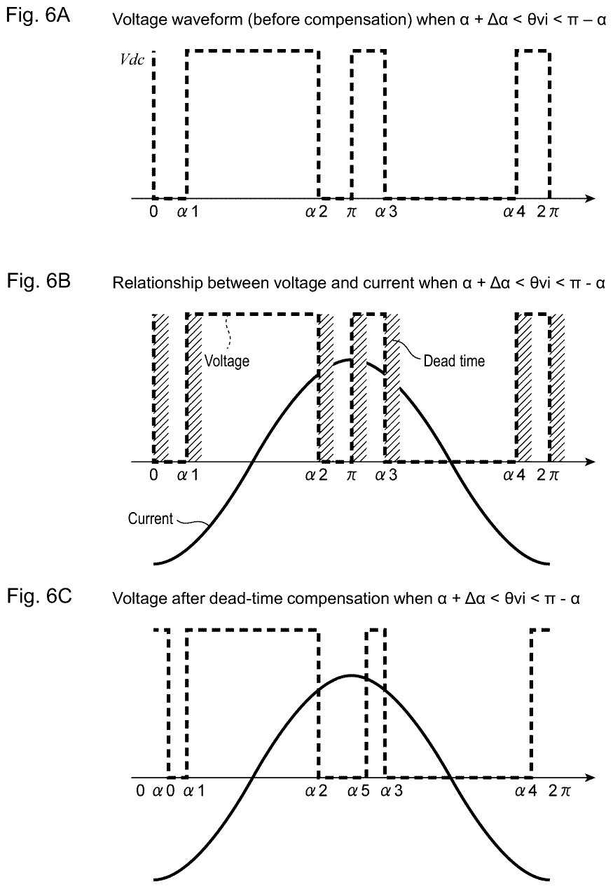

FIG. 6 shows explanatory diagrams of the calculations of the dead-time compensation unit 183 when (2) α+Δα<θvi<π−α is satisfied.

When (2) α+Δα<θvi<π−α is satisfied, the relationship between the output voltage of the inverter 10 prior to dead-time compensation and the current flowing through the motor 3 is as shown in the middle (b) of FIG. 6. The output voltage after dead-time compensation when (2) α+Δα<θvi<π−α is satisfied has the waveform as shown at the bottom (c) of FIG. 6. The switch timings α0 to α5 shown at the bottom (c) of FIG. 6 can be expressed using the firing angle α and the dead time Δα as in Formula 15.

α0=Δα

α1=α

α2=π−α

α5=π+Δα

α3=π+α

α4=2 π−α [Formula 15]

The dead-time compensation unit 183 can calculate the Fourier coefficients an and bn as in Formula 16.

$${a}_{n} \approx \frac{2 Vdc}{π} ( 2 cos α - 1 ) \qquad [ Formula 16 ]$$

$${b}_{n} \approx \frac{2 Vdc}{π} ( Δ α )$$

Thus, the dead-time compensation unit 183 can calculate the amplitude A of the output voltage of the inverter 10 using the Fourier coefficients an and bn of Formula 16, as in Formula 17.

$$A = \frac{4}{π} ( 2 cos α - 1 ) \qquad [ Formula 17 ]$$

Compared with Formula 7 and Formula 8, which were explained using FIG. 4, the dead-time compensation unit 183 can calculate the amplitude error ΔA and the phase angle error Δθ when (2) α+Δα<θvi<π−α is satisfied, as in Formula 18.

ΔA=0

Δθ=Δα [Formula 18]

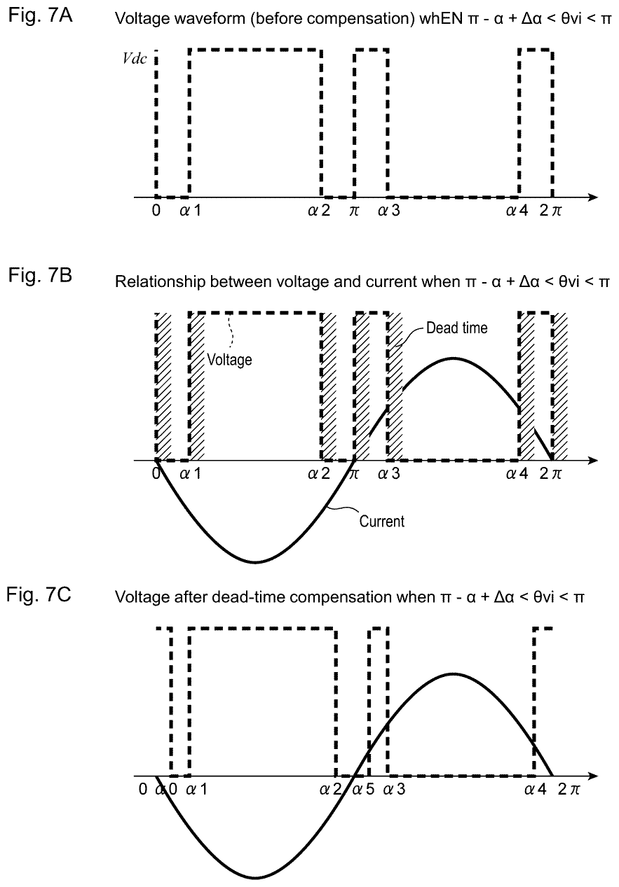

FIG. 7 shows explanatory diagrams of the calculations of the dead-time compensation unit 183 when (3) π−α+Δα<θvi<π is satisfied.

When (3) π−α+Δα<θvi<π is satisfied, the relationship between the output voltage of the inverter 10 prior to dead-time compensation and the current flowing through the motor 3 is as shown in the middle (b) of FIG. 7. The output voltage after dead-time compensation when (3) π−α+Δα<θvi<π is satisfied has the waveform as shown at the bottom (c) of the FIG. 7. The switch timings α0 to α5 shown at the bottom (c) of FIG. 7 can be expressed using the firing angle α and the dead time Δα, as in Formula 19.

Δ0=Δα

α1=α

α2=π−α+Δα

α5=π+Δα

α4=2π−α+Δα [Formula 19]

The dead-time compensation unit 183 can calculate the Fourier coefficients an and bn as in Formula 20.

$${a}_{n} \approx \frac{2 Vdc}{π} ( 2 cos α + Δ α sin α - 1 ) \qquad [ Formula 20 ]$$

$${b}_{n} \approx \frac{2 Vdc}{π} \{ ( 1 - cos α ) Δ α \}$$

Thus, the dead-time compensation unit 183 can calculate the amplitude A of the output voltage of the inverter 10 using the Fourier coefficients an and bn of Formula 20, as in Formula 21.

$$A = \frac{4}{π} ( 2 cos α + Δ α sin α - 1 ) \qquad [ Formula 21 ]$$

Compared with Formula 7 and Formula 8, which were explained using FIG. 4, the dead-time compensation unit 183 can calculate the amplitude error ΔA and the phase angle error Δθ when (3) π−α+Δα<θvi<π is satisfied, as in Formula 22.

$$Δ A = \frac{4}{π} ( Δ α sin α ) \approx \frac{4}{π} ( Δ α \times α ) \qquad [ Formula 22 ]$$

$$Δ θ \approx 0$$

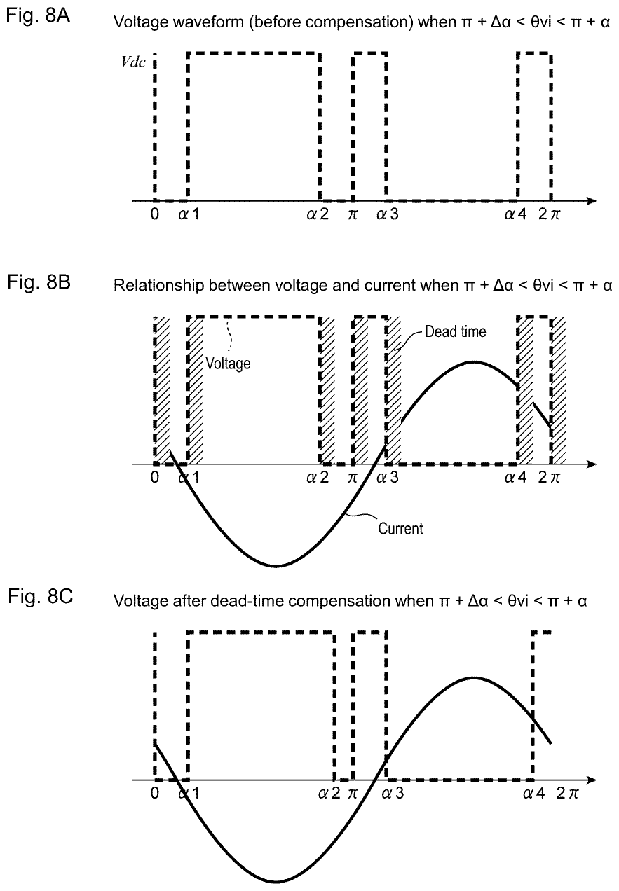

FIG. 8 shows explanatory diagrams of the calculations of the dead-time compensation unit 183 when (4) π+Δα<θvi<π+α is satisfied.

When (4) π+Δα<θvi<π+α is satisfied, the relationship between the output voltage of the inverter 10 prior to dead-time compensation and the current flowing through the motor 3 is as shown in the middle (b) of FIG. 8. The output voltage after dead-time compensation when (4) π+Δα<θvi<π+α is satisfied is as shown at the bottom (c) of FIG. 8. The switch timings α1 to α4 shown at the bottom (c) of FIG. 8 can be expressed using the firing angle α and the dead time Δα, as in Formula 23.

α1=α

α2=π−α+Δα

α3=π+α

α4=2π−α+Δα [Formula 23]

The dead-time compensation unit 183 can calculate the Fourier coefficients an and bn as in Formula 24.

$${a}_{n} \approx \frac{2 Vdc}{π} ( 2 cos α + Δ α sin α - 1 ) \qquad [ Formula 24 ]$$

$${b}_{n} \approx \frac{2 Vdc}{π} ( - Δ αcos α )$$

Thus, the dead-time compensation unit 183 can calculate the amplitude A of the output voltage of the inverter 10 using the Fourier coefficients an and bn of Formula 24, as in Formula 25.

$$A = \frac{4}{π} ( 2 cos α + Δ α sin α - 1 ) \qquad [ Formula 25 ]$$

Compared with Formula 7 and Formula 8, which were explained using FIG. 4, the dead-time compensation unit 183 can calculate the amplitude error ΔA and the phase angle error Δθ when (4) π+Δα<θvi<π+α is satisfied, as in Formula 26.

$$Δ A \approx \frac{4}{π} ( Δ α \times α ) \qquad [ Formula 26 ]$$

$$Δ θ \approx - Δ α$$

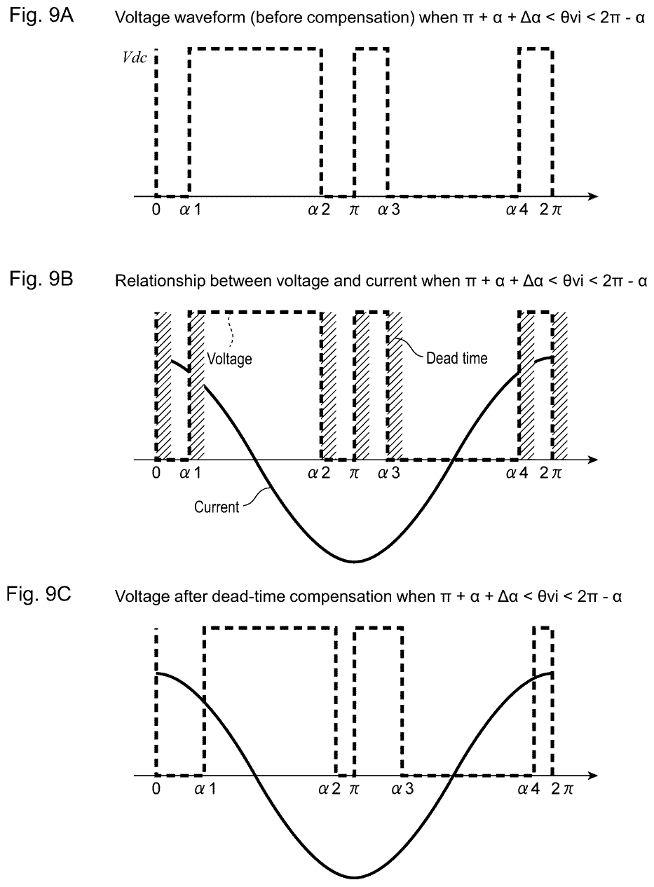

FIG. 9 shows explanatory diagrams of the calculations of the dead-time compensation unit 183 when (5) π+α+Δα<θvi<2π−α is satisfied.

When (5) π+α+Δα<θvi<2π−α is satisfied, the relationship between the output voltage of the inverter 10 prior to dead-time compensation and the current flowing through the motor 3 is as shown in the middle (b) of FIG. 9. The output voltage after dead-time compensation when (5) π+α+Δα<θvi<2π−α is satisfied is as shown at the bottom (c) of FIG. 9. The switch timings α1 to α4 shown at the bottom (c) of FIG. 9 can be expressed using the firing angle α and the dead time Δα, as in Formula 27.

α1=α+Δα

α2=π−α+Δα

α3=π+α+Δα

α4=2π−α+Δα [Formula 27]

The dead-time compensation unit 183 can calculate the Fourier coefficients an and bn as in Formula 28.

$${a}_{n} \approx \frac{2 Vdc}{π} ( 2 cos α - 1 ) \qquad [ Formula 28 ]$$

$${b}_{n} \approx \frac{2 Vdc}{π} ( - 2 Δ αcos α )$$

Thus, the dead-time compensation unit 183 can calculate the amplitude A of the output voltage of the inverter 10 using the Fourier coefficients an and bn of Formula 28, as in Formula 29.

$$A = \frac{4}{π} ( 2 cos α - 1 ) \qquad [ Formula 29 ]$$

Compared with Formula 7 and Formula 8, which were explained using FIG. 4, the dead-time compensation unit 183 can calculate the amplitude error ΔA and the phase angle error Δθ when (5) π+α+Δα<θvi<2π−α is satisfied, as in Formula 30.

ΔA=0

Δθ≅−2Δα [Formula 30]

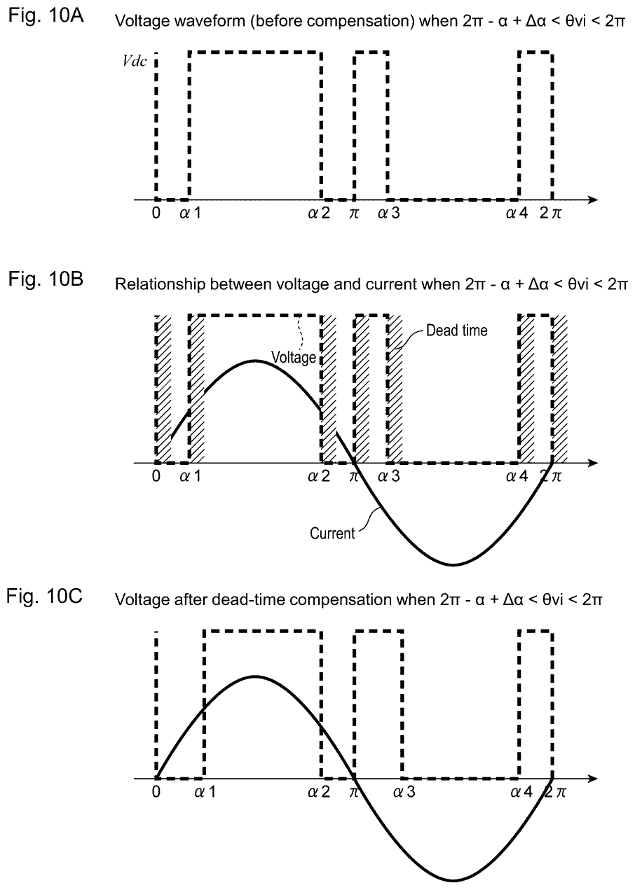

FIG. 10 shows explanatory diagrams of the calculations of the dead-time compensation unit 183 when (6) 2π−α+Δα<θvi<2π is satisfied.

When (6) 2π−α+Δα<θvi<2π is satisfied, the relationship between the output voltage of the inverter 10 prior to dead-time compensation and the current flowing through the motor 3 is as shown in the middle (b) of FIG. 10. The output voltage after dead-time compensation when (6) 2π−α+Δα<θvi<2π is satisfied is as shown at the bottom (c) of FIG. 10. The switch timings α1 to α4 shown at the bottom (c) of FIG. 10 can be expressed using the firing angle α and the dead time Δα, as in Formula 31.

α1=α+Δα

α2=π−α

α3=π+α+Δα

α4=2π−α [Formula 31]

The dead-time compensation unit 183 can calculate the Fourier coefficients an and bn as in Formula 32.

$${a}_{n} \approx \frac{2 Vdc}{π} ( 2 cos α - Δ α sin α - 1 ) \qquad [ Formula 32 ]$$

$${b}_{n} \approx \frac{2 Vdc}{π} ( - Δ αcos α )$$

Thus, the dead-time compensation unit 183 can calculate the amplitude A of the output voltage of the inverter 10 using the Fourier coefficients an and bn of Formula 32, as in Formula 33.

$$A = \frac{4}{π} ( 2 cos α - Δ α sin α - 1 ) \qquad [ Formula 33 ]$$

Compared with Formula 7 and Formula 8, which were explained using FIG. 4, the dead-time compensation unit 183 can calculate the amplitude error ΔA and the phase angle error Δθ when (6) 2π−α+Δα<θvi<2π is satisfied as in Formula 34.

$$Δ A \approx \frac{4}{π} ( - Δ α \times α ) \qquad [ Formula 34 ]$$

$$Δ θ \approx - Δ α$$

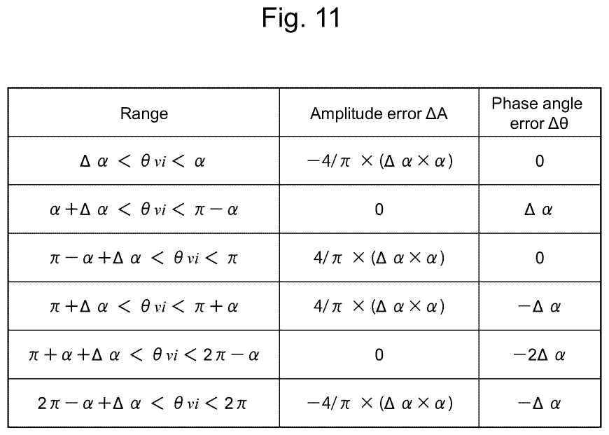

FIG. 11 is a table showing the relationship between the difference θvi between the voltage phase angle θv and the current phase angle θi, and the amplitude error ΔA and the phase angle error Δθ. The table of FIG. 11 summarizes the amplitude error ΔA and the phase angle error Δθ calculated for each of the cases shown in FIG. 5 to FIG. 10.

In each of the cases (1) to (6), which were explained using FIG. 5 to FIG. 10, the amplitude error ΔA and the phase angle error Δθ show different values, as shown in FIG. 11. The three-pulse/one-pulse calculation unit 180 corrects the modulation factor MF, which is used for calculating the firing angle α of the output voltage, using the amplitude error ΔA corresponding to the range of the difference θvi shown in FIG. 11. The three-pulse/one-pulse calculation unit 180 also corrects the phase angles θ1 and θ2 of the output voltage using the phase angle error Δθ corresponding to the range of the difference Ovi. In this way, the three-pulse/one-pulse calculation unit 180 can have the inverter 10 output an output voltage that accounts for the dead time with respect to the required voltage. Note that, as shown in FIG. 11, when the amplitude error ΔA is zero, the three-pulse/one-pulse calculation unit 180 may not need to correct the modulation factor MF. Similarly, when the phase angle error Δθ is zero, the three-pulse/one-pulse calculation unit 180 may not need to correct the phase angles θ1 and θ2 of the output voltage.

Additionally, the dead-time compensation unit 183 may calculate the amplitude error ΔA and the phase angle error Δθ in an intermediate case between (6) 2π−α+Δα<θvi<2π and (1) Δα<θvi<α, such as in the interval [0, Δα], for example, by performing linear interpolation from the amplitude error ΔA and the phase angle error Δθ calculated for each respective range. Alternatively, since Aa is a minute quantity, dead-time compensation unit 183 may set the amplitude error ΔA and the phase angle error Δθ each to zero in an intermediate case between (6) 2π−±Δα<θvi<2π and (1) Δα<θvi<α.

The firing angle calculation unit 184 calculates the firing angle α of the output voltage of the inverter 10 on the basis of the amplitude error ΔA calculated as the dead-time compensation amount and the modulation factor MF. Specifically, the firing angle calculation unit 184 adds the amplitude error ΔA calculated as the dead-time compensation amount to the modulation factor MF as an operation quantity and then calculates the firing angle α from the modulation factor MF with the amplitude error ΔA added. In detail, the firing angle calculation unit 184 can calculate the firing angle α using Formula 35.

$$α = {cos}^{- 1} ( \frac{\frac{π}{4} MF + 1 + Δ A}{2} ) \qquad [ Formula 35 ]$$

The phase angle calculation unit 185 calculates the phase angles θ1 and θ2 of the output voltage of the inverter 10 on the basis of the phase angle error Δθ calculated as the dead-time compensation amount and the electric angle θp of the motor 3. The phase angle θ1 indicates the phase angle of the output voltage at the next control timing. The phase angle θ2 indicates the phase angle of the output voltage at the control timing after the next. Specifically, the phase angle calculation unit 185 considers the electrical angle deviation ωtc per carrier cycle, which is calculated from the electrical angular velocity ω of the motor 3 and the carrier period tc, to be a one-sample delay of the phase angle. Then, the phase angle calculation unit 185 adds the phase angle error Δθ calculated as the dead-time compensation amount to the previous voltage phase angle θv as an operation quantity to calculate the phase angles θ1 and θ2. In detail, when the rotational speed of the motor 3 is positive, the phase angle calculation unit 185 calculates the phase angles θ1 and θ2 using Formula 36.

$$θ 1 = θ p + \frac{π}{2} + ω {t}_{c} + ( θ v + Δ θ ) \qquad [ Formula 36 ]$$

$$θ 2 = θ p + \frac{π}{2} + 2 ω {t}_{c} + ( θ v + Δ θ )$$

When the rotational speed of the motor 3 is negative, the phase angle calculation unit 185 can calculate the phase angles θ1 and θ2 by changing (+π/2) on the right-hand side of Formula 36 to (−π/2). Formula 36 represents the phase angles θ1 and θ2 of one phase (e.g., the U-phase) of the three-phase voltage. When calculating the phase angles θ1 and θ2 of the other phases of the three-phase voltage (e.g., the V-phase or the W-phase), the phase angle calculation unit 185 can calculate the phase angles θ1 and θ2 of the other phases by shifting the phase angles θ1 and θ2 calculated using Formula 36 by 120 degrees.

The duty calculation unit 186 calculates the duty ratio duvw in each phase of the three-phase voltage from the firing angle α of the output voltage calculated by the firing angle calculation unit 184, and the phase angles θ1 and θ2 of the output voltage calculated by the phase angle calculation unit 185, and determines the position of each pulse edge (switch timing). Then, the duty calculation unit 186 outputs the calculated position of each pulse edge to the PWM pulse generation unit 150.

The PWM pulse generation unit 150 generates a PWM pulse signal P corresponding to the calculated position of each pulse edge and outputs the PWM pulse signal P to the gate circuit 160. The gate circuit 160 outputs the drive signal DR corresponding to the PWM pulse signal P to the inverter 10. The semiconductor switch elements of the inverter 10 are controlled to turn on and off by the drive signal DR. Consequently, the output voltage of the inverter 10 is adjusted.

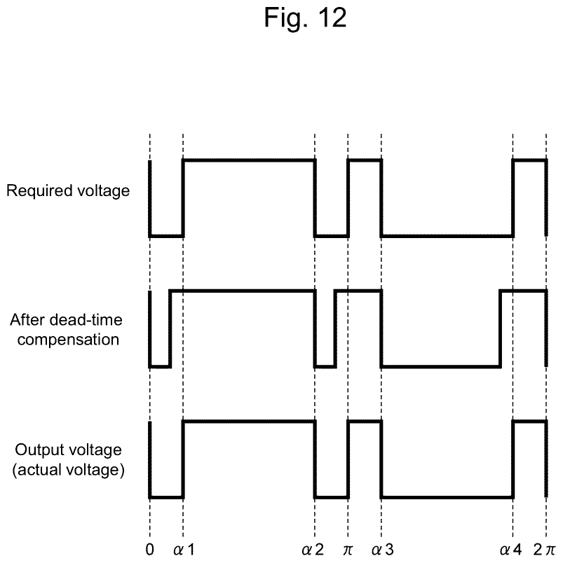

FIG. 12 illustrates the operational effects of the inverter control device 100 shown in FIG. 1.

As described above, the inverter control device 100 of Embodiment 1 is a device that controls the switching operation of the inverter 10, which converts a direct-current voltage into an alternating-current voltage and applies the alternating-current voltage to the motor 3, by pulse width modulation. The inverter control device 100 of Embodiment 1 is provided with the dead-time compensation unit 183 that performs dead-time compensation to compensate for an error of the output voltage of the inverter 10 caused by the dead time of the inverter 10. The dead-time compensation unit 183 performs dead-time compensation on the basis of the difference θvi between the current phase angle θi, which indicates the phase angle for outputting the current of the motor 3 and the voltage phase angle θv for outputting a voltage corresponding to the current.

Consequently, the inverter control device 100 of Embodiment 1 can perform dead-time compensation for the required voltage, allowing the output voltage of the inverter 10 to match the required voltage, as shown in FIG. 12. Thus, the inverter control device 100 of Embodiment 1 can reduce the voltage error caused by the dead time. In addition, the dead-time compensation unit 183 of Embodiment 1 can perform dead-time compensation on the basis of the difference θvi between the voltage phase angle θv, which can be calculated from the dq-axis voltage command values Vdq*, and the current phase angle θi, which can be calculated from the dq-axis current command values Idq*. Thus, the inverter control device 100 of Embodiment 1 does not need to perform high-speed current detection as in conventional systems, and can perform dead-time compensation easily. Accordingly, the inverter control device 100 of Embodiment 1 can easily reduce the voltage error caused by the dead time during the switching from the SVPWM control mode to the three-pulse control mode, thereby suppressing torque shock.

Furthermore, the inverter control device 100 of Embodiment 1 is provided with the modulation factor/voltage phase angle calculation unit 181 for calculating the modulation factor MF and the voltage phase angle θv of the output voltage, and the current phase angle calculation unit 182 for calculating the current phase angle θi. The inverter control device 100 of Embodiment 1 is provided with the firing angle calculation unit 184 for calculating the firing angle α of the output voltage, and the phase angle calculation unit 185 for calculating the phase angles θ1 and θ2 of the output voltage. The dead-time compensation unit 183 calculates at least one of the amplitude error ΔA and the phase angle error Δθ of the output voltage caused by the dead time as the dead-time compensation amount. The firing angle calculation unit 184 calculates the firing angle α on the basis of the amplitude error ΔA calculated as the dead-time compensation amount and the modulation factor MF. The phase angle calculation unit 185 calculates the phase angles θ1 and θ2 on the basis of the phase angle error Δθ calculated as the dead-time compensation amount.

Consequently, the inverter control device 100 of Embodiment 1 can calculate the firing angle α and the phase angles θ1 and θ2 such that the amplitude error ΔA and the phase angle error Δθ can be rectified even when the amplitude error ΔA and the phase angle error Δθ vary due to the range of the difference Ovi. Thus, the inverter control device 100 of Embodiment 1 can appropriately compensate for the voltage error even when the voltage error caused by the dead time varies in accordance with the phase difference between the output voltage of the inverter 10 and the current flowing through the motor 3. Accordingly, the inverter control device 100 of Embodiment 1 can easily and reliably reduce the voltage error caused by the dead time and reliably suppress torque shock.

Hence, in the inverter control device 100 of Embodiment 1, the dead-time compensation unit 183 performs dead-time compensation when the switching operation is controlled by the three-pulse control mode.

Consequently, the inverter control device 100 of Embodiment 1, when controlled by the three-pulse control mode, can easily reduce the voltage error caused by the dead time and suppress torque shock. In particular, the inverter control device 100 of Embodiment 1 can suppress the torque shock that has conventionally occurred during the switching from the SVPWM control mode to the three-pulse control mode. In addition, the inverter control device 100 of Embodiment 1 can suppress the torque shock that occurs during the switching from the three-pulse control mode to the SVPWM control mode. Accordingly, the inverter control device 100 of Embodiment 1 can stabilize the operation of the motor 3.

### Embodiment 2

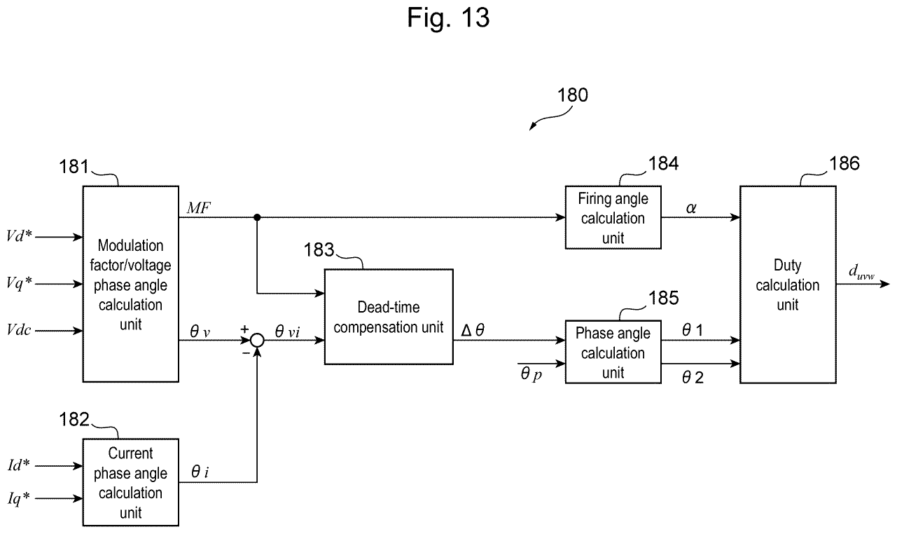

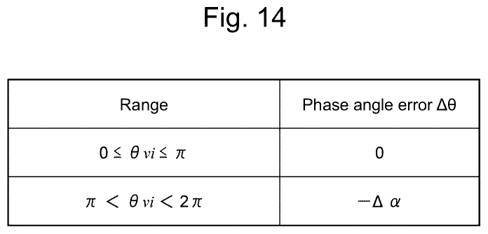

With reference to FIG. 13 and FIG. 14, the inverter control device 100 of Embodiment 2 will be described. In the inverter control device 100 of Embodiment 2, the configuration and operation similar to those of Embodiment 1 will be omitted from the description. FIG. 13 is a configuration diagram of the three-pulse/one-pulse calculation unit 180 provided in the inverter control device 100 of Embodiment 2. FIG. 14 is a table showing the relationship between the difference θvi between the voltage phase angle θv and the current phase angle θi, and the phase angle error Δθ.

In Embodiment 2, an example will be described in which the inverter control device 100 controls the switching operation in the one-pulse control mode.

In the case of the one-pulse control mode, too, when the Fourier coefficients an and bn are calculated in the same way as in the case of the three-pulse control mode described in Embodiment 1, the relationship between the range of the difference Ovi and the phase angle error Δθ is as shown in FIG. 14. That is, as shown in FIG. 14, in the case of the one-pulse control mode, there is no need to calculate the amplitude error ΔA as the dead-time compensation amount, and there is no need to correct the modulation factor ME.

Thus, the dead-time compensation unit 183 of Embodiment 2 only calculates the phase angle error Δθ as the dead-time compensation amount on the basis of the difference θvi. The phase angle calculation unit 185 of Embodiment 2, as in Embodiment 1, calculates the phase angles θ1 and θ2 of the output voltage on the basis of the phase angle error Δθ calculated as the dead-time compensation amount and the electric angle θp of the motor 3. Meanwhile, the firing angle calculation unit 184 of Embodiment 2 calculates the firing angle α of the output voltage on the basis of the modulation factor MF that has not been corrected.

Consequently, the inverter control device 100 of Embodiment 2 can simplify the control logic compared to Embodiment 1 because it does not need to calculate the amplitude error ΔA as the dead-time compensation amount and does not need to correct the modulation factor ME. Accordingly, the inverter control device 100 of Embodiment 2 can further easily reduce the voltage error caused by the dead time and suppress torque shock.

In addition, in the inverter control device 100 of Embodiment 2, the dead-time compensation unit 183 performs dead-time compensation when the switching operation is controlled by the one-pulse control mode.

Consequently, the inverter control device 100 of Embodiment 2, when controlled by the one-pulse control mode, can easily reduce the voltage error caused by the dead time and suppress torque shock. In particular, the inverter control device 100 of Embodiment 2 can suppress the torque shock that occurs during the switching from the three-pulse control mode to the one-pulse control mode. In addition, the inverter control device 100 of Embodiment 2 can suppress the torque shock that occurs during the switching from the one-pulse control mode to the three-pulse control mode. Accordingly, the inverter control device 100 of Embodiment 2 can further stabilize the operation of the motor 3.

### Embodiment 3

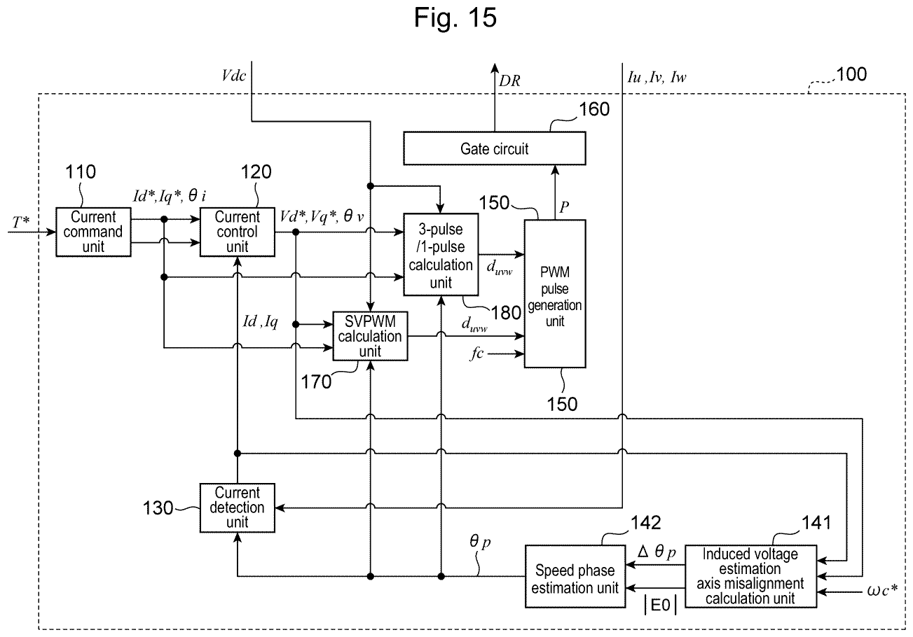

With reference to FIG. 15, the inverter control device 100 of Embodiment 3 will be described. In the inverter control device 100 of Embodiment 3, the configuration and operation similar to those of Embodiment 1 will be omitted from the description. FIG. 15 is a configuration diagram of the inverter control device 100 of Embodiment 3.

In Embodiment 3, the reduction of the voltage error caused by the dead time is utilized not only for torque shock suppression but also for estimating the position of the rotor of the motor 3.

The inverter control device 100 of Embodiment 3 is provided with, in place of the rotational position detection unit 140 (or as part of the rotational position detection unit 140), an induced voltage estimation axis misalignment calculation unit 141 and a speed phase estimate unit 142. The other configurations of the inverter control device 100 of Embodiment 3 are the same as those of Embodiment 1.

The induced voltage estimation axis misalignment calculation unit 141 estimates the induced voltage E0 of the motor 3 from the dq-axis voltage command values Vdq*, the dq-axis current detected values Idq, and the speed command value ωr* that commands the motor rotational speed. Then, the induced voltage estimation axis misalignment calculation unit 141 calculates the axis misalignment estimate value Δθp from the phase of the estimated induced voltage E0. The speed phase estimate unit 142 estimates the rotational position θp, which is the position of the rotor of the motor 3, from the magnitude |E0| of the induced voltage E0 and the axis misalignment estimate value Δθp.

The method for estimating the rotational position θp from the induced voltage E0 estimated using the dq-axis voltage command values Vdq* is disclosed in JP 3411878 B. The inverter control device 100 of Embodiment 3 can incorporate the method disclosed in JP 3411878 B.

When the voltage error occurs due to the dead time, in the above method of estimating the dq-axis voltage command values Vdq* using the rotational position θp, the voltage error due to the dead time is superimposed on the phase of the induced voltage E0 as an error, thereby deteriorating the accuracy of estimation of the rotational position θp. However, since the inverter control device 100 of Embodiment 3 can reduce the voltage error caused by the dead time as in Embodiment 1, it can improve the accuracy of estimation of the rotational position θp. The same applies to the estimation of the magnetic flux and torque of the motor 3 using the dq-axis voltage command values Vdq*, allowing the inverter control device 100 of Embodiment 3 to improve the accuracy of estimation of the magnetic flux and torque of the motor 3 using the dq-axis voltage command value Vdq*.

### Others

It should be noted that the present invention is not limited to the above embodiments and may include various modifications. For example, the above embodiments have been described in detail to facilitate understanding of the present invention and are not necessarily limited to including all of the described configurations. Additionally, part of the configuration of one embodiment may be replaced with that of another embodiment, and a configuration of one embodiment may also be added to another embodiment. Furthermore, with respect to part of the configuration of each embodiment, it is possible to perform addition, deletion, or replacement of or with another configuration.

Furthermore, the above-described configurations, functions, processing units, processing means, and the like may be implemented in hardware by designing all or part of them, for example, as an integrated circuit. Alternatively, the configurations, functions, and the like may be implemented in software by having a processor interpret and execute a program that realizes each function. The information such as programs, tapes, and files that realize each function can be stored in a memory, a recording device such as a hard disk or SSD (solid-state drive), or a recording medium such as an IC card, SD card, or DVD.

The control lines and information lines shown are those deemed necessary for explanation and do not necessarily represent all control and information lines in an actual product. In practice, it may be assumed that almost all configurations are interconnected.

### REFERENCE SIGNS LIST

3 Motor (alternating-current motor)
10 Inverter
100 Inverter control device
181 Modulation factor/voltage phase angle calculation unit
182 Current phase angle calculation unit
183 Dead-time compensation unit
184 Firing angle calculation unit
185 Phase angle calculation unit

1. An inverter control device for controlling a switching operation of an inverter that converts a direct-current voltage into an alternating-current voltage and applies the alternating-current voltage to an alternating-current motor, by pulse width modulation,
the inverter control device comprising a dead-time compensation unit for performing dead-time compensation for compensating for an error of an output voltage of the inverter caused by a dead time of the inverter,
wherein the dead-time compensation unit performs the dead-time compensation on the basis of a difference between a current phase angle indicating a phase angle for outputting a current of the alternating-current motor and a voltage phase angle for outputting a voltage corresponding to the current.

2. The inverter control device according to claim 1, further comprising:
a modulation factor/voltage phase angle calculation unit for calculating a modulation factor of the output voltage and the voltage phase angle;
a current phase angle calculation unit for calculating the current phase angle;
a firing angle calculation unit for calculating a firing angle of the output voltage; and
a phase angle calculation unit for calculating the phase angle of the output voltage,
wherein:
the dead-time compensation unit calculates at least one of an amplitude error and a phase angle error of the output voltage caused by the dead time as a dead-time compensation amount;
the firing angle calculation unit calculates the firing angle on the basis of the amplitude error calculated as the dead-time compensation amount and the modulation factor; and
the phase angle calculation unit calculates the phase angle on the basis of the phase angle error calculated as dead-time compensation amount.

3. The inverter control device according to claim 1, wherein the dead-time compensation unit performs the dead-time compensation when the switching operation is controlled by at least one of a one-pulse control mode and a three-pulse control mode.
